(19) United States
(12) Patent Application Publication
(10) Pub. No.: US 2018/0273815 A1
(43) Pub. Date: Sep. 27, 2018

(54) ACTINIC RADIATION-INITIATED EPOXY ADHESIVE AND ARTICLES MADE THEREFROM

(71) Applicant: 3M INNOVATIVE PROPERTIES COMPANY, St. Paul, MN (US)

(72) Inventors: Zachary J. Thompson, Woodbury, MN (US); Michael A. Kropp, Cottage Grove, MN (US); Scott B. Charles, Spring Valley, WI (US); Jayshree Seth, Woodbury, MN (US)

(21) Appl. No.: 15/763,855

(22) PCT Filed: Sep. 30, 2016
(86) PCT No.: PCT/US2016/054705

§ 371 Date: Mar. 28, 2018

Related U.S. Application Data
(60) Provisional application No. 62/236,202, filed on Oct. 2, 2015.

(51) Int. Cl. C09J 163/00; C08G 59/68; C08G 59/40; C09J 5/00

(52) U.S. Cl. CPC C09J 163/00; C08G 59/68; C09J 2205/31; C09J 5/00; C09J 2463/00; C08G 59/4064

(57) ABSTRACT

There is provided a one part, actinic radiation-activated, and room temperature curable epoxy-based adhesive. There is also provided an adhesive initiator system based on an iodonium salt combined with an thioxanthone photosensitizer such as isopropyl thioxanthone. There are also provided methods of use and articles made using such one part, actinic radiation-activated, and room temperature curable epoxy-based adhesive comprising an adhesive initiator system comprising an iodonium salt combined with a thioxanthone photo sensitizer.

### FIELD

This disclosure relates to actinic radiation-initiated epoxy adhesive, method of using such adhesives, and articles made therefrom.

### BACKGROUND

Manufacturers, such as consumer electronics manufacturers, appliance manufacturers, vehicle manufacturers, and the like, are increasingly converting from tapes to liquid adhesives for product assembly as designs become ever more complex. For example, the rise of larger display areas, curved surfaces, and diversified material selection necessitates an alternative to conventional foam or double-sided tapes. Hot melt moisture-cure urethane adhesives have recently become the dominant solution to fulfill these bonding needs. These adhesives typically offer very good shear and impact performance, fast handling strength, do not require precision mixing, and allow automated device assembly. However, urethane adhesives often have very short open times, which can inhibit wet-out and bonding, have poor pot life, and require a very long time to achieve full cure.

There is a need for a liquid adhesive mixture that provides more flexibility in manufacturing processes used to create goods, such as consumer electronics, appliances, vehicles, and the like. There is a need for a liquid adhesive mixture that remains stable until it is exposed to actinic radiation, at which point the liquid adhesive undergoes cationic cure. There is also a need for a liquid adhesive mixture in which the cationic cure continues to progress even in the absence of further irradiation. There is a further need for an adhesive initiator system that enables formulation of adhesives that may still wet substrates even after exposed to actinic radiation.

### SUMMARY

The present disclosure provides a one-part, room temperature curable adhesive with an extremely long open time when not directly exposed to actinic radiation irradiation. Once triggered by an actinic radiation source, the presently disclosed adhesives maintain good wettability and will continue to “dark cure” with a rate of strength build desirable for many commercial applications.

The above summary of the present disclosure is not intended to describe each embodiment of the present invention. The details of one or more embodiments of the invention are set forth in the description below. Other features, objects, and advantages of the invention will be apparent from the description.

### DETAILED DESCRIPTION

Before any embodiments of the invention are explained in detail, it is to be understood that the invention is not limited in its application to the details of construction and the arrangement of components set forth in the following description. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Any numerical range recited herein includes all values from the lower value to the upper value. For example, if a concentration range is stated as 1% to 50%, it is intended that values such as 2% to 40%, 10% to 30%, or 1% to 3%, etc., are expressly enumerated. These are only examples of what is specifically intended, and all possible combinations of numerical values between and including the lowest value and the highest value enumerated are to be considered to be expressly stated in this application.

The presently disclosed liquid adhesive addresses many of the process deficiencies inherent in conventional solutions. Epoxy-based adhesives disclosed herein are one part, actinic radiation-activated, and room temperature curable. An adhesive initiator system useful in the present disclosure is based on an iodonium salt, e.g., a tolylcumyliodonium salt, combined with an thioxanthone photosensitizer. Thioxanthone photosensitizers comprise a thioxanthone moiety and may optionally be substituted, e.g., with alkyl groups, such as in isopropyl thioxanthone, with halo groups, such as in chlorothioxanthone, or with alkoxy groups. The presently disclosed liquid adhesive mixture remains essentially indefinitely stable until it is exposed to actinic radiation, such as for example UV-A radiation, at which point the epoxy adhesive undergoes cationic cure. The cationic cure is effectively a living polymerization and will continue to progress even in the absence of further irradiation, unlike the conventional photo-polymerization of acrylic adhesives. The presently disclosed adhesive initiator system enables the formulation of adhesives that may still wet substrates even after exposed to actinic radiation, such as for example UV-A radiation. Adhesives are described herein that maintain acceptable wet out and flow for up to ten to twenty minutes after activation, while developing handling strength in under an hour. This will provide flexibility with regard to assembly processes.

In some embodiments, the present disclosure provides a method for bonding an adhesive to a substrate. In some embodiments, the present disclosure provides a method for bonding two substrates together. In some embodiments, the presently disclosed method includes the steps of: providing a liquid adhesive composition; dispensing the liquid adhesive composition on a first substrate; and activating the liquid adhesive with an actinic radiation source. In some embodiments, the presently disclosed method includes the steps of: providing a liquid adhesive composition; dispensing the liquid adhesive composition on a first substrate; positioning a second substrate on a surface of the liquid adhesive that is not in contact with the first substrate; and activating the liquid adhesive with an actinic radiation source.

Substrates can include thermoplastics, such as polycarbonates, including polycarbonate-ABS, and the like; metals, such as aluminum, magnesium, alloys thereof, and the like; glass, such as sodium borosilicate glass, soda-lime glass, and quartz glass, sapphire, and the like.

Actinic radiation sources useful in the present disclosure include a UV light source, a digital light projector (DLP) with a light emitting diode (LED), a DLP with a blacklight fluorescent lamp, a laser scanning device with a laser, a liquid crystal display (LCD) panel with a backlight, a photomask with a lamp, or a photomask with an LED, and the like. In some embodiments, the liquid adhesive mixture is exposed to various levels of UV-A energy using a low intensity mercury vapor lamp having a Type D bulb, such as that commercially available under the trade designation “FUSION UV CURING SYSTEM” from Fusion UV Systems Inc., Gaithersburg, Md. Total UV-A (320-390 nm) energy can be determined using a radiometer, such as that commercially available under the trade designation “UV POWER PUCK II” from EIT LLC, Sterling, Va.

Applications for using the presently disclosed adhesives include various applications in which it is necessary to bond to surfaces having irregular topographies, such as non-flat surfaces as well as applications in which shock impact damping and/or vibration damping are important performance criteria. Some applications include, but are not limited to, lens bonding on mobile handheld devices, electronics bonding, conformable masking tape applications, automotive dash trim bonding, solar panel bonding, window mounting and sealing, box sealing applications, personal care products, gasketing materials, protective coverings, labels, anti-slip products, insulation products, and reduced tear strength products (i.e. bandages, medical tapes, and the like). Articles contemplated in the present disclosure include any articles that are useful in any of these types of applications.

In some embodiments, the present initiator system enable the incorporation of a large amount of bio-based carbon content. In some embodiments, the adhesive according to the present disclosure has a bio-based carbon content as measured pursuant to ASTM Standard D6866-12 of greater than 30%; in other embodiments, greater than 45%; in other embodiments, greater than 55%; in other embodiments, greater than 65%; in other embodiments, greater than 70%; and in other embodiments, greater than 72%.

Various modifications and alterations of this invention will become apparent to those skilled in the art without departing from the scope and spirit of this invention.

### EXAMPLES

TABLE 1
MATERIALS

| Designation | Description |
|---|---|
| L207 | A polyfunctional linear epoxy resin, having an oxirane oxygen content of 1.4 to |
| | 2.0 milliequivalents/gram (an epoxy equivalent weight of approximately 590), |
| | available under the trade designation L207 from Kuraray Co. Ltd., Tokyo, |
| | Japan. |
| VIKOFLEX | An epoxidized vegetable oil, having an oxirane oxygen content of 7% (an |
| 9080 | epoxy equivalent weight of approximately 228), available under the trade |
| | designation VIKOFLEX 9080 from Arkema Inc., Colombes, France. |
| ESCOREZ | A cycloaliphatic hydrocarbon tackifying resin, available under the trade |
| 5380 | designation ESCOREZ 5380 from Exxon Mobil Corp., Irving, Texas. |
| PRIPOL 2033 | A fully amorphous dimer diol, having a hydroxyl number of 202 to 212, |
| | available under the trade designation PRIPOL 2033 from Croda International, |
| | Snaith, United Kingdom. |
| AEROSIL | A silane-treated fumed silica, available under the trade designation AEROSIL |
| R805 | R805 from Evonik Industries, Essen, Germany. |
| HELOXY | A diglycidyl ether of cyclohexane dimethanol, having an epoxy equivalent |
| 107 | weight of 155 to 165, available under the trade designation HELOXY 107 from |
| | Hexion Inc., Columbus, Ohio. |
| RHODORSIL | Tolylcumyliodonium tetrakis (pentafluorophenyl) borate, obtained as |
| 2074 | RHODORSIL PHOTOINITIATOR 2074 from Rhodia, La Defense, France. |
| ITX | Isopropyl thioxanthone, available from Sigma-Aldrich Corporation, Saint |
| | Louis, Missouri. |
| EPON | A bisphenol-A diglycidyl ether, having an epoxy equivalent weight of 185 to |
| RESIN 828 | 192, available under the trade designation EPON RESIN 828 |
| | from Hexion Inc., Columbus, Ohio. |
| SE-5015P | A high-purity hydrogenated bisphenol-A diglycidyl ether, having an epoxy |
| | equivalent weight of 190 to 220, available under the trade designation SE- |
| | 5015P from Shin-A T&C Co., Ltd, Seoul, Korea. |
| PRIPLAST | A semi-crystalline polyester polyol, having a weight average molecular weight |
| 3192 | of 2000, available under the trade designation PRIPLAST 3192 from Croda |
| | International, Snaith, United Kingdom. |
| 3M LIGHT- | A one component liquid acrylic adhesive which cures and changes color upon |
| CURE | exposure to visible or UV light, available under the trade designation 3M |
| ADHESIVE | LIGHT-CURE ADHESIVE LC-1214 from 3M Company, St. Paul, MN. |
| LC-1214 | |
| 3M SCREEN | A screen printable, 100% solids acrylic-based composition that can be UV |
| PRINTABLE | cured to provide a high tack pressure sensitive adhesive, available under the |
| UV-CURING | trade designation 3M SCREEN PRINTABLE UV-CURING ADHESIVE 7555 |
| ADHESIVE | from 3M Company, St. Paul, MN. |
| 7555 | |
| RE 100L | An ester of Tall Oil Rosin, available under the trade designation of |
| | SYLVALITE RE 100L from Arizona Chemical, Jacksonville, Florida. |
| FORAL | A glycerol ester of highly hydrogenated refined wood rosin, available under the |
| 85LB | trade designation of FORAL 85LB from Pinova, Inc., Brunswick, Georgia. |
| FORAL 3085 | A glycerol ester of highly hydrogenated rosin, available under the trade |
| | designation of FORAL 3085 from Pinova, Inc., Brunswick, Georgia. |

### Preparation of Compositions A and B

A photoinitiator stock solution containing 30 parts by weight HELOXY 107, 20 parts RHODORSIL P 2074, and 2 parts by weight ITX was prepared by dissolving the RHODORSIL 2074 and ITX in the HELOXY 107 until a homogeneous mixture was achieved. The components of Compositions A and B were mixed in cups using a DAC 400 FVZ SPEEDMIXER from FlackTek Inc., Landrum, S.C., for 30 seconds at 2,000 revolutions per minute (rpm) and 30 seconds at 2,500 rpm. The photoinitiator stock solution was added last to minimize accidental light exposure. The cups were briefly checked to ensure the thixotrope was fully dispersed and the mixture was homogeneous. Compositions A and B were then loaded into black 30 milliliter cartridges to provide convenient dispensing of the curable compositions. The formulations of Compositions A and B are reported in Table 2.

TABLE 2
COMPOSITIONS

Composition
(weight percent)

| Component | A | B |
|---|---|---|
| L207 | 18 | |
| VIKOFLEX 9080 | 18 | |
| ESCOREZ 5380 | 43 | |
| PRIPOL 2033 | 15.5 | |
| EPON RESIN 828 | | 53 |
| SE-5015P | | 13 |
| PRIPLAST 3192 | | 28 |
| AEROSIL R805 | 4.5 | 5 |
| Photoinitiator Stock | 1 | 1 |
| Total | 100 | 100 |

### Examples 1-6 and Comparative Examples A-F

For each of the following Examples and Comparative Examples, an approximately 2 millimeter thick bead of adhesive was dispensed across the entire width of a 1 inch wide by 4 inch long transparent polycarbonate (PC) plastic coupon using an EFD 1500XL DISPENSER from Nordson EFD, Westlake, Ohio. Immediately after dispensing, the coupons were placed on the conveyor of a FUSION UV CURING SYSTEM from Fusion UV Systems Inc., Gaithersburg, Md. where they were exposed to various levels of UV-A energy using a low intensity mercury vapor lamp having a Type D bulb. The total UV-A (320-390 nm) energy was determined using a UV POWER PUCK II radiometer from EIT LLC, Sterling, Va. The total energy exposure was varied by adjusting the conveyor speed. Immediately after UV exposure a second 1 inch by 4 inch PC coupon was placed on top of the bead coated surface of the first coupon and the two coupons were bonded together at room temperature with a force of 16 pounds/square inch for 10 seconds using a EUNSUNG HEAT BONDING M/C from Eunsung Industrial Co., Ltd., Ansan, South Korea. The areas before and after the bonding process were marked and recorded. The percent change in area was defined as the difference between the initial and final areas divided by the initial area. The results reported in Table 3.

TABLE 3

| | | Total UV-A | Initial | Final | |
|---|---|---|---|---|---|
| | | Energy | Area | Area | |
| | | (Joules/ | (square | (square | Area |
| | Compo- | square | milli- | milli- | Change |
| Example | sition | centimeter) | meters) | meters) | (%) |
| 1 | A | 1 | 39 | 122 | 210 |
| 2 | A | 2.5 | 47 | 127 | 170 |
| 3 | A | 5 | 43 | 101 | 135 |
| 4 | B | 1 | 39 | 229 | 481 |
| 5 | B | 2.5 | 52 | 62 | 20 |
| 6 | B | 5 | 44 | 44 | 0 |
| Comparative | LC 1214 | 1 | 63 | 57 | −10 |
| Example A | | | | | |
| Comparative | LC 1214 | 2.5 | 44 | 55 | 23 |
| Example B | | | | | |
| Comparative | LC 1214 | 5 | 43 | 51 | 18 |
| Example C | | | | | |
| Comparative | 7555 | 1 | 77 | 87 | 13 |
| Example D | | | | | |
| Comparative | 7555 | 2.5 | 76 | 84 | 10 |
| Example E | | | | | |
| Comparative | 7555 | 5 | 43 | 60 | 38 |
| Example F | | | | | |

### Examples 7-14 and Comparative Examples G-N

Examples 7-14 and Comparative Examples G-N were prepared as described for Examples 1-6 and Comparative Examples A-F with the following modifications. The UV-A exposure was fixed at 2.5 Joules/square centimeter and the time elapsed before the coupons were joined was varied. The results are reported in Table 4.

TABLE 4

| | | | Initial | Final | |
|---|---|---|---|---|---|
| | | Time | Area | Area | |
| | | Before | (square | (square | Area |
| | Compo- | Bonding | milli- | milli- | Change |
| Example | sition | (minutes) | meters) | meters) | (%) |
| 7 | A | 0 | 47 | 127 | 170 |
| 8 | A | 5 | 57 | 112 | 96 |
| 9 | A | 10 | 55 | 94 | 72 |
| 10 | A | 20 | 55 | 91 | 67 |
| 11 | B | 0 | 52 | 62 | 20 |
| 12 | B | 5 | 48 | 60 | 24 |
| 13 | B | 10 | 48 | 57 | 18 |
| 14 | B | 20 | 56 | 56 | 0 |
| Comparative | LC 1214 | 0 | 44 | 55 | 23 |
| Example G | | | | | |
| Comparative | LC 1214 | 5 | 44 | 47 | 6 |
| Example H | | | | | |
| Comparative | LC 1214 | 10 | 43 | 50 | 15 |
| Example I | | | | | |
| Comparative | LC 1214 | 20 | 44 | 48 | 9 |
| Example J | | | | | |
| Comparative | 7555 | 0 | 76 | 84 | 10 |
| Example K | | | | | |
| Comparative | 7555 | 5 | 52 | 70 | 34 |
| Example L | | | | | |
| Comparative | 7555 | 10 | 57 | 56 | −2 |
| Example M | | | | | |
| Comparative | 7555 | 20 | 39 | 41 | 3 |
| Example N | | | | | |

### Examples 15-22 and Comparative Examples O-V

Examples 15-22 and Comparative Examples O-V were prepared as described for Examples 1-6 and Comparative Examples A-F with the following modifications. The UV-A exposure was fixed at 1.0 Joules/square centimeter and the time elapsed before the coupons were joined was varied. The results are reported in Table 5.

TABLE 5

| | | | Initial | Final | |
|---|---|---|---|---|---|
| | | Time | Area | Area | |
| | | Before | (square | (square | Area |
| | Compo- | Bonding | milli- | milli- | Change |
| Example | sition | (minutes) | meters) | meters) | (%) |
| 15 | A | 0 | 39 | 122 | 210 |
| 16 | A | 5 | 55 | 198 | 263 |
| 17 | A | 10 | 74 | 160 | 117 |
| 18 | A | 20 | 61 | 171 | 181 |
| 19 | B | 0 | 39 | 229 | 481 |
| 20 | B | 5 | 55 | 278 | 409 |
| 21 | B | 10 | 53 | 192 | 260 |
| 22 | B | 20 | 57 | 112 | 96 |
| Comparative | LC 1214 | 0 | 63 | 57 | −10 |
| Example O | | | | | |
| Comparative | LC 1214 | 5 | 79 | 71 | −10 |
| Example P | | | | | |
| Comparative | LC 1214 | 10 | 67 | 74 | 9 |
| Example Q | | | | | |
| Comparative | LC 1214 | 20 | 79 | 89 | 13 |
| Example R | | | | | |
| Comparative | 7555 | 0 | 77 | 88 | 13 |
| Example S | | | | | |
| Comparative | 7555 | 5 | 70 | 91 | 31 |
| Example T | | | | | |
| Comparative | 7555 | 10 | 88 | 123 | 41 |
| Example U | | | | | |
| Comparative | 7555 | 20 | 72 | 132 | 82 |
| Example V | | | | | |

### Examples 23-32 and Comparative Examples W-FF

For the following Examples and Comparative Examples the compositions were used to bond overlap shear samples using 1 inch by 4 inches by 0.063 inch rectangular aluminum coupons. The substrates were wiped with isopropanol and allowed to dry in air for 30 minutes prior to bonding. Each composition was then dispensed onto an aluminum coupon and coated to an approximate thickness of 0.010 inch using a knife blade. Spacer beads, having a diameter of 0.008 to 0.010 inch were sprinkled on top of the composition to ensure a consistent thickness after bonding. The coated aluminum samples were then exposed to UV-A energy as described for Examples 15-22 and Comparative Examples 0-V. At various times after UV exposure a second 1 inch by 4 inches by 0.063 inch aluminum coupon was placed on top of the coated, exposed surface of the first coupon and the two coupons were bonded together such that a 0.5 inch overlap area was provided. The two coupons were held together at room temperature using binder clips and maintained this way for at least two days. Samples were evaluated for overlap shear strength using a tensile tester with a 2000 pound-force load cell and a separation rate of 0.1 inch/minute. The strength at failure was reported and the result are shown in Table 6.

TABLE 6

| | | Time | Overlap Shear |
|---|---|---|---|
| | | Before | Strength |
| | Compo- | Bonding | (pounds/ |
| Example | sition | (minutes) | square inch) |
| 23 | A | 0 | 114 |
| 24 | A | 2 | 84 |
| 25 | A | 5 | 78 |
| 26 | A | 10 | 55 |
| 27 | A | 20 | 52 |
| 28 | B | 0 | 603 |
| 29 | B | 2 | 409 |
| 30 | B | 5 | 428 |
| 31 | B | 10 | 504 |
| 32 | B | 20 | 230 |
| Comparative Example W | LC 1214 | 0 | 27 |
| Comparative Example X | LC 1214 | 2 | 12 |
| Comparative Example Y | LC 1214 | 5 | 11 |
| Comparative Example Z | LC 1214 | 10 | 15 |
| Comparative Example AA | LC 1214 | 20 | 13 |
| Comparative Example BB | 7555 | 0 | 4.2 |
| Comparative Example CC | 7555 | 2 | 5.2 |
| Comparative Example DD | 7555 | 5 | 4.1 |
| Comparative Example EE | 7555 | 10 | 2.6 |
| Comparative Example FF | 7555 | 20 | 2.1 |

### Examples 33-42

Examples 33-42 were prepared and evaluated as described for Examples 23-32 and Comparative Examples W-FF with the following modifications. Substrates were joined together immediately after UV exposure and allowed to stand for various lengths of time before measuring overlap shear strength. The results are reported in Table 7.

TABLE 7

| | | Time | Overlap Shear |
|---|---|---|---|
| | | Before | Strength |
| | Compo- | Testing | (pounds/ |
| Example | sition | (minutes) | square inch) |
| 33 | A | 5 | 1 |
| 34 | A | 10 | 1 |
| 35 | A | 30 | 5 |
| 36 | A | 60 | 20 |
| 37 | A | 2880 | 114 |
| 38 | B | 5 | 1 |
| 39 | B | 10 | 2 |
| 40 | B | 30 | 167 |
| 41 | B | 60 | 288 |
| 42 | B | 2880 | 603 |

### Examples 43-48 and Comparative Examples GG-II

A photoinitiator stock solution containing 30 parts by weight HELOXY 107, 20 parts by weight Rhodorsil 2074, and 2 parts by weight ITX was prepared by dissolving the Rhodorsil 2074 and ITX in the HELOXY 107 until a homogeneous mixture was achieved. Various compositions were mixed in cups using a DAC 400 FVZ SPEEDMIXER, for 30 seconds at 2,000 revolutions per minute (rpm) and 30 seconds at 2,500 rpm. The photoinitiator stock solution was added last to minimize accidental light exposure. The cups were briefly checked to ensure the mixture was homogeneous. The uncured adhesive compositions were then loaded into black 30 milliliter cartridges to provide convenient dispensing of the adhesives. The compositions of Examples 43-48 and Comparative Examples GG-II are shown in Table 8.

TABLE 8

| | COMPOSITION (wt %) | | | | | | | | |
|---|---|---|---|---|---|---|---|---|---|
| | Ex. | Ex. | Ex. | Ex. | Ex. | Ex. | CE | CE | CE |
| Component | 43 | 44 | 45 | 46 | 47 | 48 | GG | HH | II |
| L207 | 20 | | 20 | 20 | | | 19 | 18 | |
| EPON 828 | | 20 | | | 20 | 20 | | | 53 |
| VIKOFLEX 9080 | 20 | 20 | 20 | 20 | 20 | 20 | 19 | 18 | |
| SE-5015P | | | | | | | | | 13 |
| PRIPOL 2033 | 11 | 11 | 11 | 11 | 11 | 11 | 11.5 | 15.5 | |
| PRIPLAST 3192 | | | | | | | | | 28 |
| ESCOREZ 5380 | | | | | | | 45.5 | 43 | |
| RE 100L | 48 | 48 | | | | | | | |
| FORAL 85LB | | | 48 | | 48 | | | | |
| FORAL 3085 | | | | 48 | | 48 | | | |
| AEROSIL R805 | | | | | | | 5 | 4.5 | 5 |
| Photoinitiator | 1 | 1 | 1 | 1 | 1 | 1 | 1 | 1 | 1 |
| Stock | | | | | | | | | |

### Peel Adhesion Strength

The uncured adhesive compositions of Examples 43-48 and Comparative Examples GG-II were used to prepare tape samples which were then evaluated for peel adhesion strength as follows. For each composition an approximately 0.05 millimeter (0.002 inches) thick film of uncured adhesive composition was coated onto a polyethylene terephthalate (PET) backing using a knife blade. Immediately after coating, the uncured adhesive coated films were placed on the conveyor of a HERAEUS NOBLELIGHT FUSION UV CURING SYSTEM from Fusion UV Systems Inc., Gaithersburg, Md., where they were exposed to UV irradiation using a low intensity mercury vapor lamp having a Type D bulb. The coated composition was exposed to a total UVA energy (320-390 nm) of 2 Joules/square centimeter by adjusting the conveyor speed. The total UVA energy was determined using a UV POWER PUCK II radiometer from EIT LLC, Sterling, Va.). The cured, adhesive coated samples were allowed to stand at least 48 hours at room temperature before testing. During coating, it was noted that the composition of Example 44 had phase-separated in the cartridge at some point after mixing. This composition was not coated onto PET and was not further evaluated.

Peel adhesion strength was measured at an angle of 180° using an IMASS SP-200 SLIP/PEEL TESTER (from IMASS, Inc., Accord MA) at a peel rate of 305 millimeters/minute (12 inches/minute). Stainless steel (SS) plates were prepared for testing by cleaning with acetone and a clean KIMWIPE brand tissue one time followed by heptane and a clean KIMWIPE brand tissue three times. Polypropylene panels (PP) were prepared for testing by cleaning with isopropanol and a clean KIMWIPE brand tissue three times. The cleaned panels were allowed to dry at room temperature. The coated PET tape samples, prepared as describe above, were cut into test strips measuring 2.54 centimeters wide by 20 centimeters long (1 inch by 8 inches). A test specimen was prepared by rolling a test strip down onto a cleaned panel with 2 passes of a 2.0 kilogram (4.5 pound) rubber roller at a rate of 61 centimeters/minute (24 inches/minute). The test specimen was allowed to stand at 23° C./50% RH for 15 minutes before testing. Two test specimen were evaluated for each example and the average value reported. The results are shown in Table 9.

TABLE 9
PEEL ADHESION STRENGTH

Peel Adhesion Strength
ounces/inch (Newtons/millimeters)

| Example | SS | PP |
|---|---|---|
| 43 | 0.2 (0.002) | 0.2 (0.002) |
| 45 | 9.8 (0.11) | 9.4 (0.10) |
| 46 | 21.0 (0.23) | 23.8 (0.26) |
| 47 | 12.2 (0.13) | 3.8 (0.04) |
| 48 | 17.6 (0.19) | 12.0 (0.13) |
| CE GG | 41.3 (0.45) | 46 (0.50) |
| CE HH | 24.3 (0.26) | 23.9 (0.26) |

### Overlap Shear Strength

The uncured adhesive compositions of Examples 47 and 48, and Comparative Examples HH and II, were used to bond overlap shear samples which were then evaluated for overlap shear strength as follows. Aluminum test substrates measuring 2.5 centimeters (1 inch) wide, 10.2 centimeters (4 inches) long, and 1.6 millimeters (0.063 inches) thick were wiped with isopropanol and allowed to dry in air for 30 minutes prior to bonding. Uncured adhesive composition was then dispensed onto the cleaned aluminum and coated to an approximate thickness of 0.25 millimeters (0.010 inches) using a knife blade. Spacer beads, having a diameter of 0.20 to 0.25 millimeters (0.008 to 0.010 inches), were sprinkled on top of the uncured compositions to ensure a consistent thickness after bonding. The coated aluminum test substrates were then placed on the conveyor of a FUSION UV CURING SYSTEM where they were exposed to UV irradiation using a low intensity mercury vapor lamp having a type D bulb. The coated composition was exposed to a total UVA energy (320-390 nm) of 1 Joule/square centimeter by adjusting the conveyor speed. The total UVA energy was determined using a UV POWER PUCK II radiometer. Next, a second aluminum test substrate having the same dimensions as the first one and cleaned in the same manner was placed onto the exposed cured adhesive surface of the first test substrate and the two were bonded together such that a 12.7 millimeter (0.5 inch) overlap area in the lengthwise direction was provided. The two test substrates were held together at room temperature using binder clips and maintained this way for at least two days to provide test specimens. The resulting test specimens were evaluated for overlap shear strength using a tensile tester with a 2000 pound-force load cell and a separation rate of 2.54 millimeters (0.1 inches/minute). Three test specimens were evaluated and the average value was reported. The results are shown in Table 10.

TABLE 10
OVERLAP SHEAR STRENGTH

| | Overlap Shear Strength |
|---|---|
| | Pounds/square inch |
| Example | (MegaPascals) |
| 47 | 580 (4.00) |
| 48 | 720 (4.96) |
| CE HH | 114 (0.79) |
| CE II | 603 (4.20) |

### Bio-Based Carbon Content

The percent bio-based carbon for Examples 45-48 and Comparative Example GG were quantified using ASTM Standard D6866-12. The percent of bio-based carbon present in the uncured compositions was determined from the measured radiocarbon (¹⁴C) in dpm/gC (disintegrations per minute per gram carbon) and corrected for isotopic fractionation based on measured stable carbon isotope ratio (delta ¹³C) (% V-PDB). ¹⁴C activity was converted to pMC (percent modern carbon) and multiplied by 95%. This represented the equivalence to the 1950 ¹⁴C reference activity of 13.56 dpm/gC corrected for bomb-produced ¹⁴C. The standard deviation (sigma) of the percent bio-based carbon measurement is rounded to the nearest integer. The results are shown in Table 11.

TABLE 11

| | | | ¹⁴C | |
|---|---|---|---|---|
| | ¹⁴C | delta¹³C | Corrected | Bio-Based Carbon |
| Example | (dpm/gC) | (% PDB) | (dpm/gC) | (% ± sigma) |
| 45 | 10.36 ± 0.07 | −27.87 | 10.42 | 73 ± 1 |
| 46 | 10.56 ± 0.07 | −28.05 | 10.63 | 74 ± 1 |
| 47 | 10.19 ± 0.07 | −28.71 | 10.26 | 72 ± 1 |
| 48 | 9.97 ± 0.07 | −28.75 | 10.04 | 70 ± 1 |
| CE GG | 3.65 ± 0.03 | −28.25 | 3.68 | 26 ± 1 |

We claim:

1. A curable adhesive comprising:
a) at least one epoxy-functional resin; and
b) an adhesive initiator system comprising:
i) an iodonium salt, and
ii) a thioxanthone photosensitizer.

2. The curable adhesive according to claim 1 wherein the thioxanthone photosensitizer is selected from the group consisting of alkylthioxanthone photosensitizers, alkoxythioxanthone photosensitizers, and halothioxanthone photosensitizers.

3. The curable adhesive according to claim 1 wherein the thioxanthone photosensitizer is an isopropyl thioxanthone photosensitizer.

4. The curable adhesive according to claim 1 wherein the thioxanthone photosensitizer is an isopropyl chlorothioxanthone photosensitizer.

5. The curable adhesive according to claim 1 wherein the iodonium salt is a tolylcumyliodonium salt.

6. The curable adhesive according to claim 1, which is a one-part adhesive comprising a shelf-stable mixture of the epoxy-functional resin and the adhesive initiator system.

7. The curable adhesive according to claim 1, which is a liquid at standard temperature and pressure.

8. The curable adhesive according to claim 1 having a bio-based carbon content as measured pursuant to ASTM Standard D6866-12 of greater than 25%.

9. The curable adhesive according to claim 1 having a bio-based carbon content as measured pursuant to ASTM Standard D6866-12 of greater than 30%.

10. The curable adhesive according to claim 1 having a bio-based carbon content as measured pursuant to ASTM Standard D6866-12 of greater than 55%.

11. The curable adhesive according to claim 1 which may be cured at room temperature by application of actinic radiation.

12. The curable adhesive according to claim 11 wherein the actinic radiation is UV radiation.

13. A cured adhesive obtained by curing the curable adhesive according to claim 1.

14. A method of bonding an adhesive to a substrate comprising the steps of:
a) providing a curable adhesive according to claim 1;
b) dispensing the curable adhesive on a first substrate; and
c) initiating cure of the curable adhesive by application of actinic radiation.

15. A method of bonding a first substrate to a second substrate comprising the steps of:
a) providing a curable adhesive according to claim 1;
b) dispensing the curable adhesive on a first substrate;
c) initiating cure of the curable adhesive by application of actinic radiation; and
d) positioning a second substrate on a surface of the curable adhesive that is not in contact with the first substrate.

16. The method according to claim 14 wherein steps b) and c) are carried out at room temperature.

17. The method according to claim 15 wherein steps b), c) and d) are carried out at room temperature.
